(19) United States
(12) Patent Application Publication
(10) Pub. No.: US 2011/0129274 A1
(43) Pub. Date: Jun. 2, 2011

(54) PRINTING APPARATUS AND ABNORMALITY DETERMINING METHOD

(75) Inventors: Yasuo Sunaga, Shiojiri-shi (JP); Tomoyoshi Kakegawa, Matsumoto-shi (JP)

(73) Assignee: SEIKO EPSON CORPORATION, Tokyo (JP)

(21) Appl. No.: 12/949,082

(22) Filed: Nov. 18, 2010

(30) Foreign Application Priority Data
Nov. 30, 2009 (JP) 2009-272457

(51) Int. Cl. B41J 11/42

(52) U.S. Cl. 400/582

(57) ABSTRACT

A printing apparatus includes a tray loading a medium and detachably mounted to a main body; a transport roller rotated by driving of a transport motor to transport the medium while coming into contact with the medium supplied from the tray to a transport path; a print, condition setting unit setting a print mode among a plurality of print modes in which different transport speeds are different; a control unit controlling the driving of the transport motor based on the set print mode and a rotational amount of the transport roller; a threshold value setting unit setting a threshold value corresponding to at least the set print, mode; and a determination unit measuring a monitoring value indicating a load of the transport motor during a transport period of the medium and determining there is an abnormality when the monitoring value is larger than the set threshold value.

Priority is claimed under 35 U.S.C. § 119 to Japanese Application No. 2009-272457 filed on Nov. 30, 2009, which is hereby incorporated by reference in its entirety.

### BACKGROUND

1. Technical Field

The present invention relates to a printing apparatus and an abnormality determining method.

2. Related Art

For a printer performing printing on the label surface of a DVD or a CD, a technique for determining abnormality in transport of a disk tray loading the DVD or the CD based on the current of a transport motor has been suggested (see JP-A-2005-74905). When an obstacle interferes with the disk tray, slipping occurs between a transport roller and the disk tray. Thus, excessive current causing the slipping flows in the transport motor. By detecting the excessive current based on threshold value determination, it is possible to detect the abnormality in the transport of the disk tray indirectly.

In JP-A-2005-74905, it can be considered that the magnitude of the excessive current when the slipping occurs between the transport roller and the disk tray corresponds with the magnitude of friction resistance between the transport roller and the disk tray. When abnormality in transport of a print sheet is detected in a printer using a wide variety of print modes, sheet kinds, or sheet sizes, there are various references for determining abnormality or normality. Therefore, in the method disclosed in JP-A-2005-74905, a problem may arise in that the threshold value determination is performed based on only one reference which is the magnitude of the friction resistance. That is, when print conditions such as the print modes, the sheet kinds, or the sheet sizes are different, the amount of current supplied to the transport motor is also different upon performing normal printing. Therefore, a problem may arise in that an erroneous determination result occurs in the determination using the fixed threshold value.

### SUMMARY

An advantage of some aspects of the invention is that it provides a printing apparatus and an abnormality determining method capable of accurately determining abnormality in transport of respective print media under various print conditions.

According to an aspect of the invention, there is provided a printing apparatus including: a sheet feeding tray loading a print medium and detachably mounted to a main body; a transport roller rotated by driving of a transport motor to transport the print medium while coming into contact with the print medium supplied from the sheet feeding tray to a transport path; a print condition setting unit setting a print mode among a plurality of print modes in which transport speeds are different; a control unit controlling the driving of the transport motor based on the set print mode and a rotational, amount of the transport roller; a threshold value setting unit setting a threshold value corresponding to at least the set print mode; and a determination unit measuring a monitoring value indicating a load of the transport motor during a transport period of the print medium and determining there is an abnormality when the monitoring value is larger than the set threshold value. As long as the monitoring value indicates the load state of the transport motor, the monitoring value may indicate the load state of the transport motor, may indicate voltage or a current to be applied to the transport motor under the control of the controller, may indicate a duty ratio of a PWM pulse or the like when the controller performs PWM control for the transport motor.

The controller supplies the driving power to the transport motor so that the rotational amount of the transport roller becomes a target value (a target value in the set print mode). Therefore, when abnormality occurs in the print medium, the load of the transport motor becomes an abnormal value in particular, when the print medium is pinched between the main body and the sheet feeding tray and thus the print sheet may not be transported (the print medium is not moved), the transport roller slips (idly rotates) against the frictional resistance between the transport roller and the print medium and thus, the excessive load occurs in the transport motor to the degree to which causes the slipping, in this situation, when the monitoring value which indicates the load of the transport motor is larger than the threshold value, it is determined that there is an abnormality. In this way, it is possible to prevent abnormal printing in which the print medium is not normally transported but ink is elected. However, the load of the transport motor is different depending on a difference in the print speeds, that is, a difference in the print modes. According to the invention, the threshold value is set in accordance with at least the set print mode. Therefore, since the determination suitable for each print mode can be performed, it is possible to prevent erroneous determination of abnormality even though the normal load (monitoring value) is obtained for the print mode at that time. In contrast, it is possible to prevent erroneous determination of normality even though an abnormal load (monitoring value) is obtained for the print mode at that time.

The transport path has a curved part in which the transport direction of the print medium is curved on the rear side of the transport roller in the transport direction of the print medium. The transport path is formed in a compact manner by transporting the print medium in a curved manner, and it is possible to miniaturize the printing apparatus. Along the transport path, if the print medium is pinched between the main body and the sheet feeding tray, a tensional force stretching the print medium is applied. Then, a pressing force pressing the print medium toward the roller disposed inside the curved portion of the print medium is applied and thus the print medium will tend to detach from the roller disposed outside the curved portion. Therefore, when the printing apparatus is provided with an intermediate roller rotatably driven by the driving of the transport motor while coming into contact with the print medium from the inner side of the curved portion, the pressing force is applied to the intermediate roller. Thus, the intermediate roller may not be rotatably driven and the transport roller rotatably driven by the transport motor like the intermediate roller may not be rotatably driven either. Therefore, the controller can determine the abnormality based on the rotational amount of the transport motor.

On the other hand, when the printing apparatus is provided with an intermediate roller rotatably driven by the driving of the transport motor while coming into contact with the print medium from outer side of the curved portion, the intermediate roller can be rotatably driven freely without application of the pressing force to the intermediate roller. Therefore, when the transport motor outputs at least the load which resists against the frictional resistance between the transport roller and the print medium, the rotational amount of the transport roller is normally controlled. Accordingly, with such a configuration, abnormality is detected by determining whether the monitoring value indicating the load of the transport motor is a value causing the load which resists against the frictional resistance between the transport roller and the print medium in the print mode at that time. Even when an active roller coming into contact with the print medium in the curved portion is not provided, the rotational amount of the transport roller is normally controlled as long as the transport motor outputs at least the load which resists against the frictional resistance between the transport roller and the print medium. Therefore, even in this case, abnormality is also detected by determining whether the monitoring value indicating the load of the transport motor is a value causing the load which resists against the frictional resistance between the transport roller and the print, medium in the print mode at that time.

The threshold value setting unit may set, as the threshold value, a sum of a sheet-feeding transport measurement value indicating a load of the transport motor during a period in which the print medium is transported up to a predetermined sheet-feeding transport end position of the transport path and an allowable value that is different depending on at least the set print mode. With such a configuration, by setting the allowable value to an appropriate value corresponding to each print mode, it is possible to accurately determine normality or abnormality when any print mode is set.

The threshold value setting unit may select the allowable value corresponding to the set print mode among the plurality of allowable values calculated in advance in accordance with at least the print mode and calculated based on a difference between the sheet-feeding transport measurement value and a printing transport measurement value indicating a load of the transport motor during a transport period of the print medium to perform printing and a difference between the printing transport measurement value and an abnormality-time measurement value indicating a load of the transport motor when predetermined abnormality occurs, and may set the threshold value using the selected allowable value. With such a configuration, the allowable value calculated based on the difference between the sheet-feeding transport measurement value and the printing transport measurement value and the difference between the printing transport measurement value and the abnormality-time measurement value are prepared in advance for every print mode. Therefore, the threshold value suitable for the set print mode can be readily set and the accurate determination result can be obtained.

The threshold value setting unit may set the threshold value in accordance with kinds of print media and sizes of the print media in addition to a difference between the print modes. With such a configuration, by setting the appropriate threshold value corresponding to the difference between the kinds or sizes of the print medium, it is possible to determine normality or abnormality more accurately.

In the printing apparatus, the settable print modes may include at least a first print mode and a second print mode in which the transport speed is slower than the first print mode. When the kind of print medium is a plain sheet and the print mode is set to the first print mode, the threshold value setting unit may set the threshold value larger than the threshold value set when the kind of print medium is the plain sheet and the print mode is set to the second print mode. That is, in the first print mode in which the print speed is faster than that of the second print mode, for example, the load generated by the transport motor when a plain sheet is printed is larger than the load generated by the transport motor when the plain sheet is printed in the second print mode. Therefore, in consideration of this difference, the threshold values are also set by providing a difference in the threshold values.

The determination unit may measure the monitoring value after the print medium is transported up to a predetermined sheet-feeding transport end position of the transport path. With such a configuration, it is possible to accurately determine whether abnormality occurs in the transport after the print medium (front end of the print medium) arrives at the sheet-feeding transport end position.

As described above, according to the invention, it can he determined that the abnormality occurs particularly when the print medium is pinched between the main body and the sheet feeding tray and thus may not be transported. However, the print medium is not pinched between the main body and the sheet feeding tray during a period after the rear end portion of the print medium in the transport direction departs from the detachable mount position of the sheet feeding tray, during the transport period of the print medium. Therefore, it is desirable to reduce the processing load by stopping measuring the monitoring value during the period after the rear end portion of the print medium in the transport direction departs from the detachable mount position of the sheet feeding tray.

The technical idea of the invention can be realized by a method or a program as well as the printing apparatus. For example, a method (abnormality determining method) including processing steps executed by the units of the above-described printing apparatus or a program causing a predetermined hardware (such as a computer included in the printing apparatus) to execute the functions executed by the units of the above-described printing apparatus can be also realized according to the aspects of the invention. The printing apparatus according to the invention can be distributed in a plurality of apparatuses as well as a single apparatus.

### BRIEF DESCRIPTION OF THE DRAWINGS

The invention will be described with reference to the accompanying drawings, wherein like numbers reference like elements.

FIG. 1 is a diagram schematically illustrating the configuration of a printer.

FIG. 2 is a diagram schematically illustrating the functional configuration of the printer.

FIG. 3 is a diagram illustrating a variation in a duty value when a print sheet is transported in another print mode.

FIG. 4 is a diagram illustrating an exemplary combination of the print, modes and sheet kinds.

FIG. 5 is a diagram illustrating exemplary combinations between sheet kinds and sheet sizes.

FIG. 6 is a diagram illustrating an exemplary variation in allowable values according to print conditions.

FIG. 7 is a diagram illustrating an exemplary variation in the allowable value according to the print conditions.

FIG. 8 is a flowchart illustrating the printing with an abnormality determining process.

FIG. 9 is a diagram illustrating an exemplary variation of a duty value in the printing.

FIG. 10 is a diagram illustrating possibility of abnormality determination.

FIG. 11 is a diagram schematically illustrating the configuration of a printer according to a modified example.

FIG. 12 is a diagram schematically illustrating the configuration of a printer according to a modified example.

FIG. 13 is a diagram schematically illustrating the configuration of a printer according to a comparative example.

### DESCRIPTION OF EXEMPLARY EMBODIMENTS

Hereinafter, exemplary embodiments of the invention will be described with reference to the drawings.

### 1. OVERALL CONFIGURATION OF PRINTING APPARATUS

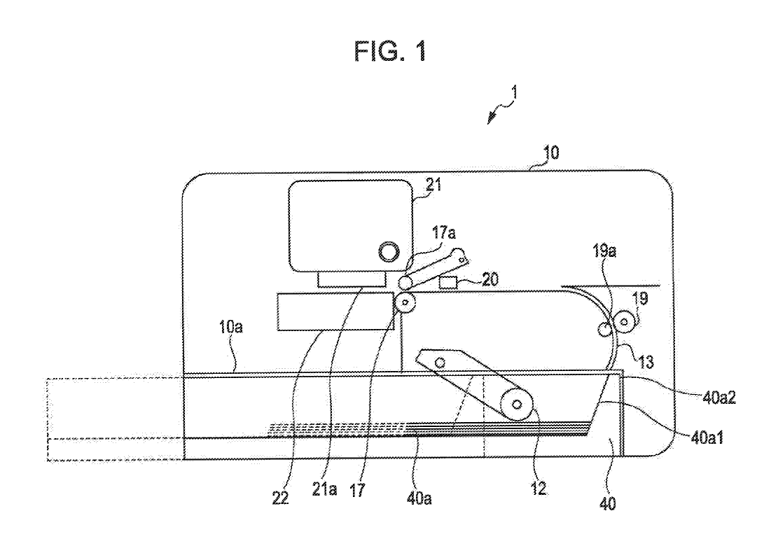

FIG. 1 is a diagram schematically illustrating the configuration of a printer 1 according to an embodiment of the invention. The printer 1 is a kind of printing apparatus. In FIG. 1, the printer 1 includes a main body 10 with a substantially rectangular shape (rectangular shape) in a side view. A slender concave section 10a is installed in the lower portion of the main body 10 in front and rear directions of the printer 1. The concave section 10a has a substantially rectangular shape in a side view, and a sheet feeding tray 40 slides forward or backward into the concave section 10a from the front side of the printer 1 and can be mounted or detached. The solid line indicates the mounted state of the sheet feeding tray 40 and the dashed line indicates the detached state of the paper sheet 40 toward the front side of the printer 1. The sheet feeding tray 40 has an outer rectangular shape slightly smaller than that of the concave section 10a and includes a sheet loading portion 40a with an open upper side therein. Print sheets as print media can be piled in the sheet loading portion 40a. The outer circumference of a PU roller (pickup roller) 12 is configured to come into contact with the uppermost placed print sheet among the print sheets placed in the sheet loading portion 40a. The PU roller 12 is coupled with a PU motor (pickup motor), a gear and the like. Thus the PU roller 12 is rotatable driven about a rotational shaft parallel to the print sheet by the driving of the PU motor. The PU motor and the PU motor 12 form a discharging unit.

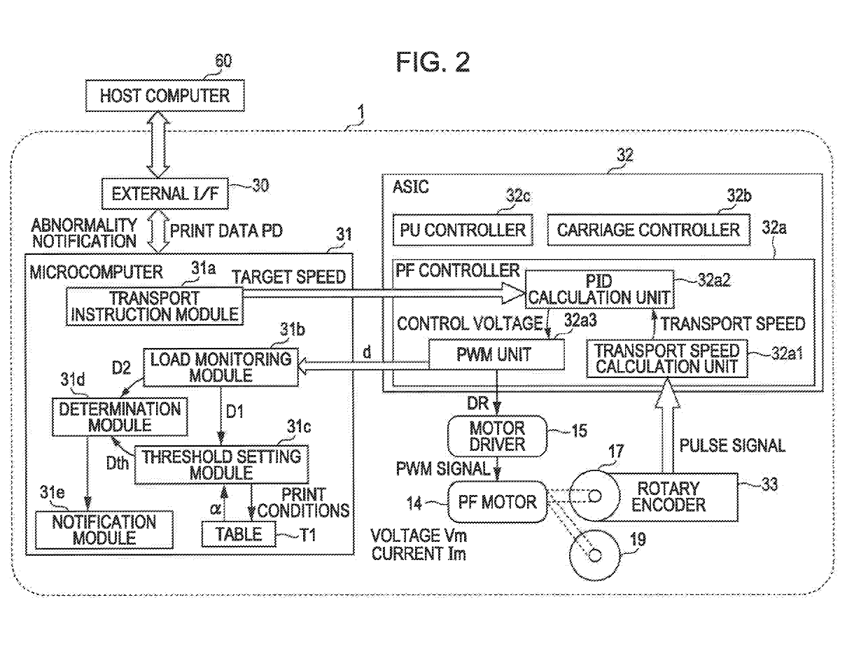

The PU roller 12 is rotated counterclockwise in FIG. 1 to send the print sheet with which the outer circumference of the PU roller comes into contact toward the rear side. Then, a rear end portion of the print sheet (hereinafter, which is used with a front end portion of the print sheet in a transport direction) is transported toward the rear side, and the front end portion of the print sheet in the transport direction then interferes with an inclined surface 40a1 formed on the rear side of the sheet loading portion 40a. The front end portion of the print sheet in the transport direction interfering with the inclined surface 40a1 is guided upward by the inclined surface 40a1. A transport guide 13 which is a curved part curved in a substantially U shape in a side view is formed above the inclined surface 40a1 in the main body 10. Therefore, the print sheet sent by the PU roller 12 is guided from the front end portion of the print sheet in the transport direction by the transport guide 13. In this way, the print sheet is supplied upward while being curved along the transport guide 13. An intermediate roller 19 is disposed in the middle of the path of the transport guide 13. The intermediate roller 19 is rotated about the rotational shaft parallel to the print sheet, while the outer circumference of the intermediate roller 19 comes into contact with the print sheet guided along the transport guide 13 from the outer side. The intermediate roller 19 is coupled with a PF motor 14 (transport motor, see FIG. 2) through a gear (not shown), so that the intermediate roller 19 is actively driven in a rotatable manner by the driving of the PF motor 14. The rotatably driven direction of the intermediate roller 19 is a clockwise direction in FIG. 1. An intermediate driven roller 19a is disposed opposite to the intermediate roller 19 with the print sheet interposed therebetween. When the intermediate roller 19 is rotatably driven, the print sheet is further transported upward along the transport guide 13 and the front side of the print sheet in the transport direction thus moves substantially horizontally toward the front side of the printer 1.

When the front side of the print sheet in the transport direction moves substantially horizontally forward for a period, the front end portion of the print sheet in the transport direction arrives at a PE sensor (sheet end sensor) 20. Since the PE sensor 20 includes a light-emitting portion and a light-receiving portion (all of which are not shown), the PE sensor 20 can detect the sheet end of the print sheet by determining whether the print sheet blocks a light path between the light-emitting portion and the light-receiving portion. In this embodiment, transporting of the print sheet during a period in which the print sheet is sent from the sheet feeding tray 40 by the PU roller 12 and the front end portion of the print sheet in the transport direction is detected by the PE sensor 20 is called “sheet-feeding transport”. Therefore, the location of the print sheet when the PE sensor 20 detects the front end portion of the print sheet in the transport direction corresponds to a predetermined sheet-feeding transport end position of the transport path.

When the PE sensor 20 detects the front end portion of the print sheet in the transport direction, the PF motor 14 performs driving to transport the print sheet from the front side thereof forward in the transport direction. Since a PF roller (transport roller) 17 is disposed on the front side of the PE sensor 20 in the transport path, the outer circumference of the PF roller 17 comes into contact with the print sheet from the lower side thereof. Since the PF roller 17 is also coupled with the PF motor 14 through a gear (not shown), the PF roller 17 is actively driven in a rotatable manner by the driving of the PF motor 14. The rotatably driven direction of the PF roller 17 is a counterclockwise direction in FIG. 1. A PF driven roller 17a is disposed opposite to the PF roller 17 with the print sheet interposed therebetween.

When the front side of the print sheet in the transport direction arrives at the PF roller 17, the print sheet is transported by the PF roller 17. When the rear end portion of the print sheet in the transport direction is located lower than the intermediate roller 19, the print sheet is transported by the rotatable driving of both the PF roller 17 and the intermediate roller 19 driven by the PF motor 14. On the other hand, when the rear end portion of the print sheet in the transport direction is located higher than the intermediate roller 19, the print sheet is also transported by the rotatable driving of both the PF roller 17 and the intermediate roller 19 driven by the PF motor 14, but the print sheet is transported by the rotatable driving of the PF roller 17. When the front end portion of the print sheet in the transport direction is located on the rear side of the PF roller 17 in the transport direction, the PF roller 17 and the intermediate roller 19 are rotatably driven in a synchronized manner by the driving of the PF motor 14, but the print sheet is transport by the rotatable driving of the intermediate roller 19. In the printer 1, the diameters of the rollers and gear ratios are set so that transport speeds at which the print sheet is transported by the PF roller 17 and the intermediate roller 19 are the same as each other.

A platen 22 is disposed in the front side of the PF roller 17. The platen 22 supports the transported print sheet from the lower side thereof. The platen 22 includes a suction mechanism (not shown). The suction mechanism sucks the print sheet downward so that the print sheet is stably held on the platen 22. A carriage 21 is disposed facing upward opposite to the platen 22 in a state where the print sheet is located therebetween. The carriage 21 includes a print head 21a in the lower portion thereof, and thus can elect ink from a plurality of nozzles arranged on the lower surface of the print head 21a. The carriage 21 can move (performs main scanning) in a direction perpendicular to the sheet surface of FIG. 1. The carriage 21 can draw raster lines in a main scanning direction in an area (print location) opposite to the nozzles on the print sheet held by the platen 22 by ejecting the ink while being performing the main scanning. By performing the main scanning and then transporting the print sheet by the driving of the PF motor, the print location on the print sheet may be displaced (sub-scanning). Therefore, the raster lines can be drawn at different positions on the print sheet. That is, by sequentially repeating the main scanning and the sub-scanning described above, a print image can be formed on the print sheet.

Transport (transport after the print sheet is transported up to the sheet-feeding transport end position) after the sheet-feeding transport can be divided into “leading end transport”, “printing transport”, and “sheet-discharging transport”. The “leading end transport” refers to transporting during a period from which the PE sensor 20 detects the front end portion of the print sheet in the transport direction to when an initial print location on the print sheet arrives at a predetermined location below the print, head 21a. The printing transport refers to transporting of the print sheet to perform printing and transporting (sub-scanning) performed between the main scanning and the main scanning. However, the leading end transport can be understood as the initial printing transport. The sheet-discharging transport refers to transporting performed to discharge the print sheet toward the front side of the printer 1 after a given print image is completely formed in the print location on the print sheet. Hereinafter, transport after the sheet-feeding transport refers to “sheet transport” as a whole.

FIG. 2 is a block diagram illustrating the functional configuration of the printer 1. The printer 1 further includes an external interface (external I/F) 30, a microcomputer 31 including a CPU, a ROM, and RAM, an ASIC 32, a rotary encoder 33, and a motor driver 15 in addition to the above-described configuration. The external I/F 30 interfaces with an external host computer 60. Print data PD is acquired from the host computer 60 via the external I/F 30. The print data PD includes, raster data for forming a print image subjected to a halftone process and control data for controlling the printer 1. The control data includes information designating the kinds of print modes, the kinds of print sheets, and the sizes of print sheets (all of which are called print conditions). A user designates the print conditions using an application program or a printer driver executed by the host computer 60. The ASIC 32 includes a PF controller 32a, a carriage controller 32b, and a PU controller (pickup roller controller) 32c, The PF controller 32a includes a transport speed calculation unit 32a1, a RID calculation unit 32a2, a PWM unit 32a3, and performs feedback control based on the set print mode and transport speed.

The transport speed calculation unit 32a1 calculates a current transport speed (which is a value proportional to a rotation amount) of the print sheet based on a pulse signal (pulse period) output from the rotary encoder 33. The rotary encoder 33 includes an encoding plate prepared for a near of either the PF roller 17 or the PF roller 17 to be coupled and further includes a light-emitting portion and a light-receiving portion interposing the encoding plate. The rotary encoder 33 generates a pulse signal with a pulse period corresponding to a rotational drive speed of the PF roller 17 based on the light received state of the light receiving portion. The PID calculation unit 32a2 performs PID calculation based on a deviation of the current transport speed from a target speed given in the microcomputer 31 to determine a control voltage to be output to the PWM unit 32a3. In the PID calculation, the control voltage of the PF motor 14 is determined by combining the proportional value of the deviation, a time integrated value, and a time differential value with each other by a predetermined gain.

PWM unit 32a3 determines a duty ratio DR corresponding to the control voltage output from the PID calculation unit 32a2 and outputs the duty ratio to the motor driver 15. The motor driver 15 generates a PWM signal as pulses by modulating a pulse width of a predetermined DC voltage Vc (for example, Vc=42 V) in accordance with the duty ratio DR (which is a ratio of an ON time to the period of the pulses), and outputs the PWM signal to the PF motor 14. The PF motor 14 is a DC motor and performs driving using the PWM signal output from the motor driver 15 as a driving source. That is, the PF motor 14 generates a load corresponding to the PWM signal (the duty ratio DR of the PWM signal). As the duty ratio DR of the PWM signal increases, the average values of a voltage Vm and a current Im to be applied to the PF motor 14 increase and the load of the PF motor 14 increases.

The duty ratio DR can be expressed as DR=d/PWMcycle. For example, the PWMcycle is an integer of 3000. Here, d is a duty value and is the numerator of the duty ratio DR. When the PWMcycle is equal to 3000, d is an integer in the range from 0 to 3000. That is, in this embodiment, the PWM unit 32a3 determines the duty ratio DR corresponding to the control voltage by adjusting the pulse period by 1/3000.

The transport speed calculation unit 32a1 and the PID calculation unit 32a2 update a control voltage based on the transport speed at every minute time (control step). That is, when the PF motor 14 performs driving, a target speed is set at every control step and the feedback control is repeated based on a deviation between the target speed and the current transport speed. On the other hand, the carriage control unit 32b performs a process of driving and controlling the carriage 21 or the print head 21a, and the PU controller 32c performs a process of driving and controlling the PU roller 12 in this embodiment, the PU motor and the PU controller 32c are independently provided, but the function (the pickup function of the print sheet) of the PU motor and the PU controller 32c may be also executed by the PF motor 14 and the PF controller 32a.

The CPU of the microcomputer 31 performs an abnormality determining process when printing described below is performed. The CPU reads a program stored in the ROM to perform the abnormality determining process by executing a transport instruction module 31a, a load monitoring module 31b, a threshold value setting module 31c, a determination module 31d, and a notification module 31e. From this point of view, the printer 1 is said to be a central unit performing an abnormality determining method. The transport instruction module 31a sets the target speed to transport the print sheet based on an instruction of the print mode or the like included as information in the print data PD, and notifies the PF controller 32a of the target speed. The load monitoring module 31b acquires a value of the load of the PF motor 14 indicated directly or indirectly. In this embodiment, the load monitoring module 31b acquires (monitors) a duty value d of the duty ratio DR determined by the PWM unit 32a3. The threshold value setting module 31c acquires, as a reference value D1, the duty value d acquired by the load monitoring module 31b during a sheet-feeding transport period. The threshold value setting module 31c acquires information designating the print mode or the like included in the print data PD and acquires an allowable value α corresponding to the print mode or the like. A correspondence relationship between the print mode and the allowable value α is recorded in a table T1 stored in advance in the ROM.

The threshold value setting module 31c calculates a threshold value Dth (=D1+α) by adding the reference value D1 and the allowable value α and sets the threshold value Dth in the determination module 31d. The determination module 31d acquires, as a monitoring value D2, a duty value d acquired by the load monitoring module 31b during a sheet transport period and determines whether the monitoring value D2 is larger than the threshold value Dth. When the monitoring value D2 is larger than the threshold value Dth, the determination module 31d determines that the print sheet is pinched between the main body 10 and the sheet feeding tray 40. When this determination is achieved, the notification module 31e notifies the outside that the print sheet is pinched between the main body 10 and the sheet feeding tray 40.

### 2. RECORDING PROCESS OF ALLOWABLE VALUE α

Next, a process of calculating the allowable value α and recording the allowable value α in the table T1 will be described. The allowable value α is recorded in the table T1 before the printing with the abnormality determining process is performed. The allowable value α is stored in the ROM of the microcomputer 31. The allowable value α is calculated to different values depending on at least the print modes. The allowable value α is expressed as Expression (1).

α=(M2−M1)+k·(M3−M2) (1)

M1 is a sheet-feeding transport measurement value and is a value indicating the load of the PF motor 14 during the sheet-feeding transport period M2 is a printing transport measurement value and is a value indicating the load of the PF motor 14 during the printing transport period M3 is an abnormality-time measurement value and is a value indicating the load of the PF motor 14 during a period (in the case where the print sheet is pinched between the main body 10 and the sheet feeding tray 40) in which predetermined abnormality occurs. The sheet-feeding transport measurement value M1, the printing transport measurement value M2, and the abnormality-time measurement value M3 are also the duty values d acquired by the load monitoring module 31b during the respective periods. Here, k is a predetermined coefficient multiplied to (M3−M2) and is set to k=1/2, for example, in this embodiment.

In this embodiment, the sheet-feeding transport measurement value M1, the printing transport measurement value M2, and the abnormality-time measurement value M3 are measured in advance to calculate the allowable value α. That is, the printer 1 which is driven under various printing conditions measures the sheet-feeding transport measurement value M1, the printing transport measurement value M2, and the abnormality-time measurement value M3 by driving various print conditions, calculates the allowable value α based on the measured measurement values M1, M2, and M3, and records the allowable value α and the print conditions in the table T1 in correspondence therewith. Since the abnormality-time measurement value M3 may not be measured in a normal operation of the printer 1, a situation where the print, sheet is pinched and stuck between the main body 10 and the sheet feeding tray 40 artificially or mechanically under each print condition is made to occur and the abnormality-time measurement value M3 is acquired by monitoring the load of the PF motor 14 performing the driving in this situation.

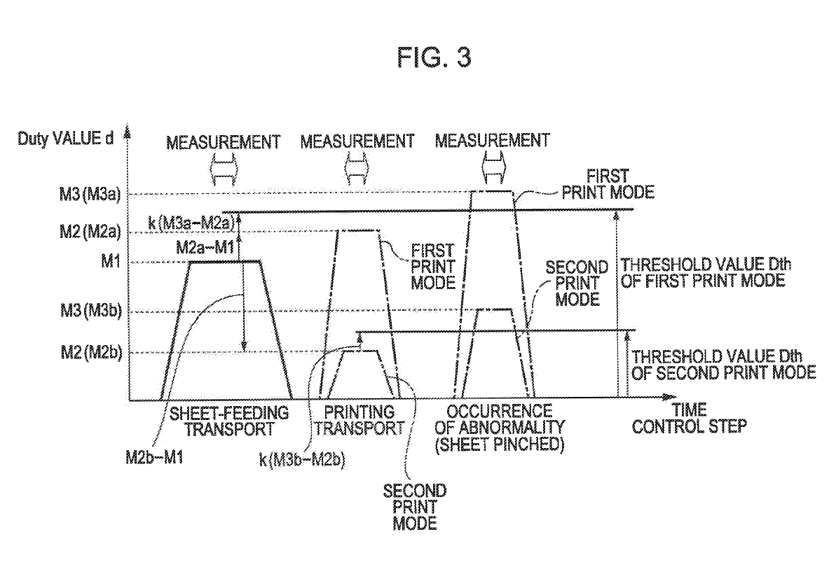

FIG. 3 is a diagram illustrating variations of the duty values d obtained when the printer 1 transport the print sheet in two different print modes (first and second print modes) and simply illustrating the variations in the duty values d during the sheet-feeding transport period, the printing transport period, and a period (abnormality occurrence period) in which the predetermined abnormality occurs after the feedback control starts. In FIG. 3, the horizontal axis represents time (control step) and the vertical axis represents the duty values d. The variation in the duty value d can, of course, be understood as a variation in the duty ratio DR or a variation in the voltage Vm applied to the PF motor 14.

The fact that the print modes are different means that the print speeds, that is, the transport speeds of the print sheet are different. For example, the print modes include a “high-speed mode”, a “normal-speed mode”, a “high quality mode”, and a “silent mode/high-precision mode” in the order in which the transport speed is faster. Since the target speed sent from the microcomputer 31 to the PID calculation unit 32a2 is different depending on a difference between the print modes, the rotational speed of the PF motor 14 is different depending on the difference between the print modes.

Hereafter, description will be made on the assumption that the transport speed of the first print mode is faster than that of the second print mode. For facilitating the description in FIG. 3, the variations of the duty values d during the sheet feeding transport period are the same as each other in the first and second print modes. Of course, the variations of the duty values d during the sheet-feeding transport period may be set to be different from each other in the first and second print modes by setting the different target speeds of the sheet-feeding transport in the first and second print modes. The variations in the duty values d during the sheet-feeding transport period show a variation which increase, are stable with a substantially constant value, and then decrease. This is because a speed acceleration period, a constant speed period, and a speed reduction period are provided in the target speed during the sheet-feeding transport. That is, since there is a relationship in which the load of the PF motor 14 increases with an increase in the transport speed in the printer 1, the duty values d and the target speed can be considered to vary in substantially the same manner.

In the printer 1, the load monitoring module 31b repeatedly measures the duty values d during a predetermined measurement period (between several control steps of the constant speed period) of the constant speed period to acquire the average value as the sheet-feeding transport measurement value M1. The sheet-feeding transport measurement value M1 is common to both the first and second print modes in the example of FIG. 3. However, when the target speed of the sheet-feeding transport is different in the first and second print modes, each sheet-feeding transport measurement value M1 needs to be acquired for the first and second print modes.

Next, the printer 1 requests the printing transport measurement value M2 from the variations in the duty values d during the printing transport period. Since there is also the constant speed period in the printing transport period, the load monitoring module 31b repeatedly measures the duty values d during a predetermined measurement period (during several control steps within the constant speed period) of the constant speed period to acquire the average value as the printing transport measurement value M2. As shown in FIG. 3, since the variation (indicated by a one-dot chain line) in the duty value d in the printing transport of the first print mode is different from the variation (indicated by a two-dot chain line) in the duty value d in the printing transport of the second print mode, the printer 1 calculates the printing transport measurement value M2 (M2a) of the first print mode and the printing transport measurement value M2 (M2b) of the second print mode.

In the printer 1, the load monitoring module 31b repeatedly measures the duty values d during the abnormality occurrence period (the abnormality occurrence period and a period in which the duty value d is stable within a predetermined range) to acquire the average value as the abnormality-time measurement value M3. As shown in FIG. 3, since the variation (indicated by a one-dot chain line) in the duty value d during the abnormality occurrence period of the first print mode is different from the variation (indicated by a two-dot chain line) in the duty value d during the abnormality occurrence period of the second print mode, the printer 1 calculates the abnormality-time measurement value M3 (M3a) of the first print mode and the abnormality-time measurement: value M3 (M3b) of the second print mode in this way, the printer 1 can calculate the respective allowable values α of the first and second print modes by obtaining the respective measurement values M1, M2, and M3 of the first and second print modes, and thus records the calculated respective allowable values α and the print modes in the table T1 in correspondence therewith. In the example of FIG. 3, the allowable value α of the first print mode calculated by Expression (1) is a positive value and the allowable value α of the second print mode is a negative value (in a case of k=1/2).

The case in which the allowable values α corresponding to the difference between the print modes are calculated in advance and recorded in the table T1 has hitherto been described. Alternatively, the printer 1 may calculate allowable values α corresponding to the kinds (sheet kinds) of the print sheet and/or the sizes (sheet sizes) of the print sheets in addition to the difference between the print modes in advance and may record the allowable values α in the table T1. That is, when the kinds or the sizes of the sheets to be used in the printing are different, the load of the PF motor 14 is varied. Therefore, the monitoring value D2 and the threshold value Dth used for comparison have to be changed in accordance with the difference between the kinds or the sizes of the sheets to be used in the printing.

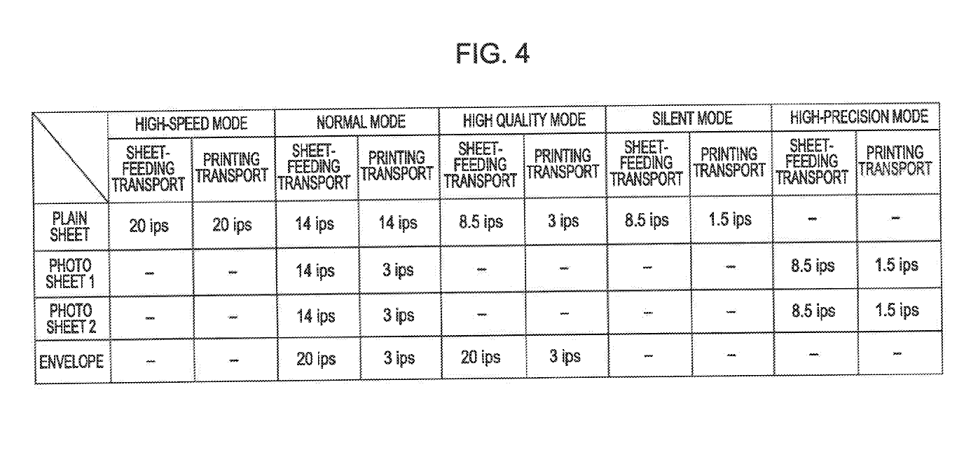

FIG. 4 is a diagram illustrating an exemplary combination of the sheet kinds and the print modes which a user can designate using the application program or the printer driver. In FIG. 4, for example, when a “plain sheet” is designated for the sheet and the “high-speed mode” is designated for the print mode, the printer 1 executes the sheet-feeding transport at a target speed of 20 ips (inch/second) and executes the printing transport at a target speed of 20 ips. The combination of the sheet kinds and the print modes in which the target speed is not described means that the designation is not possible.

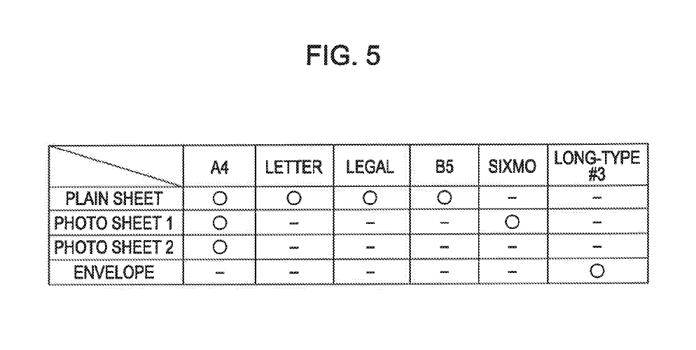

In FIG. 5, the combination of the sheet kinds and the sheet sizes which a user can designate using the application program or the printer driver is exemplified as O. The sheet kinds or the sheet sizes which the user can actually designate may be the sheet kinds or the sheet sizes which is not those shown in FIG. 5, but the sheet kinds or the sheet sizes for which the abnormality determining process needs not to be performed when the original printing is performed are excluded from those described FIG. 5. The meaning of the sheet kinds or the sheet sizes in which the abnormality determining process needs not to be performed when the original printing is performed will be described below. In the example of FIGS. 4 and 5, since the “high-speed mode” can be designated for the print mode and the “plain sheet” can be designated for the sheet kind, the sheet size can be designated among “A4”, “Letter”, “Legal”, and “B5”. Since the “high-precision mode” can he designated for the print mode and either “photo sheet 1” or “photo sheet 2” can be designated for the sheet kind, “A4” or “sixmo” can be designated for the sheet size of “photo sheet 1” and “A4” can be designated for “photo sheet 2”. In this embodiment, the allowable value α is calculated in advance for each of the combinations of the print modes, the sheet kinds, and the sheet sizes which the user can designate in this manner and is recorded in the table T1.

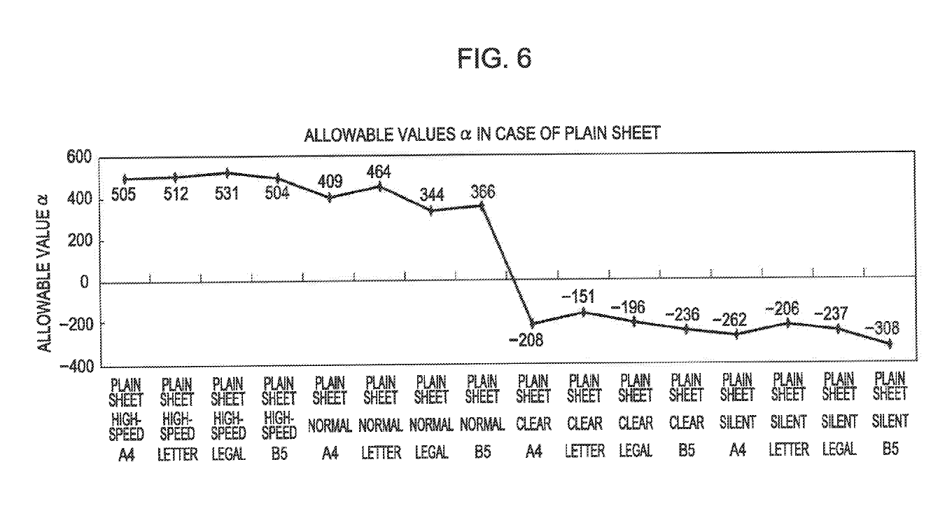

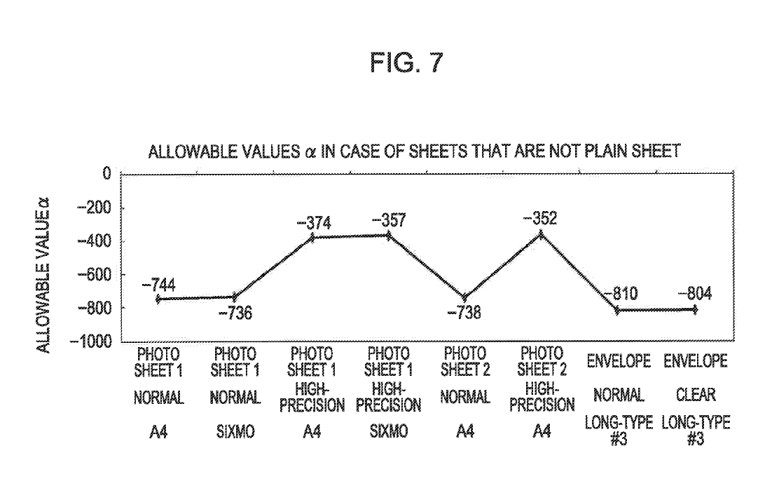

FIGS. 6 and 7 are diagram illustrating exemplary correspondence relationships between the calculated allowable values α and the print conditions. FIG. 6 shows the correspondence relationship between the allowable values α and the print conditions (see FIGS. 4 and 5) of sixteen methods when the sheet kind is the “plain sheet” and the print mode and the sheet size are changed. FIG. 7 shows the correspondence relationship between the allowable values α. and the print conditions (see FIGS. 4 and 5) of eight methods when the sheet kind is a sheet which is not the “plain sheet” and the print mode and the sheet size are changed. As is apparent from FIG. 6, when the sheet kind is the “plain sheet”, the allowable values α calculated when the print speed is a relatively fast mode (the high-speed mode and the normal mode) are all a positive value and the allowable values α calculated when the print speed is a relatively slow mode (the high quality mode and the silent mode) are all a negative value. This is because since there no difference between the target speeds of the sheet-feeding transport and the printing transport when the print speed of the plain sheet is the relatively fast mode (the high-speed mode and the normal mode) (see FIG. 4), a value obtained through M2−M1 has a tendency to be a positive value (when the target speeds are the same, the acceleration per hour easily increases in the printing transport which is shorter than the sheet-feeding transport in the transport period per one time). In addition, this is because when the print speed is the relatively slow mode (the high quality mode and the silent mode), the target speed of the printing transport is quite slower than that of the sheet-feeding transport (see FIG. 4) and the value obtained through M2−M1 has a tendency to be a negative value.

As shown in FIG. 7, when the sheet kinds are the sheets which are not the “plain sheet”, the allowable values α are all a negative value. This is because when the sheet kinds are the sheets which are not the “plain sheet”, the target speed of the printing transport is significantly slower than that of the sheet-feeding transport in any print mode (see FIG. 4) and the value obtained through M2−M1 has a tendency to be a negative value.

The duty ratio DR (=d/PWMcycle) can be expressed as Expression (2) in theory below.

DR={(z/kt)·R+ke·ω}/Vc (2)

In Expression (2), z denotes the dynamic load of the PF motor 14, kt denotes a torque integer of the PF motor 14, R denotes a coil resistant value of the PE motor 14, ke denotes an integer of counter electromotive voltage of the PF motor 14, and ω denotes the rotational speed of the PF motor 14. That is, the size of the duty ratio DR. (duty value d) can be said to largely depend on ke, that is, the transport speed of the print sheet. Therefore, the allowable value α (the threshold value Dth obtainable by adding the reference value D1 to the allowable value α) is considerably varied by the difference between the print modes (in particular, the difference between the target speed of the sheet-feeding transport and the target speed of the printing transport). For example, when the sheet is the “plain sheet A4” and the print mode is the “normal mode”, the allowable value α is 409 with reference to FIG. 6. When the print mode is the “high quality mode”, the allowable value α is −208. Therefore, even when the reference value D1 is common (in effect, the reference value D1 of the “high quality mode” is also smaller than that of the “normal mode” since the “high quality mode” is slower than the “normal mode” in the target speed of the sheet-feeding transport), the threshold value Dth of the “normal mode and the plain sheet A4” is higher than that of the “high quality mode and the plain sheet A4”.

### 3. PRINTING WITH ABNORMALITY DETERMINING PROCESS

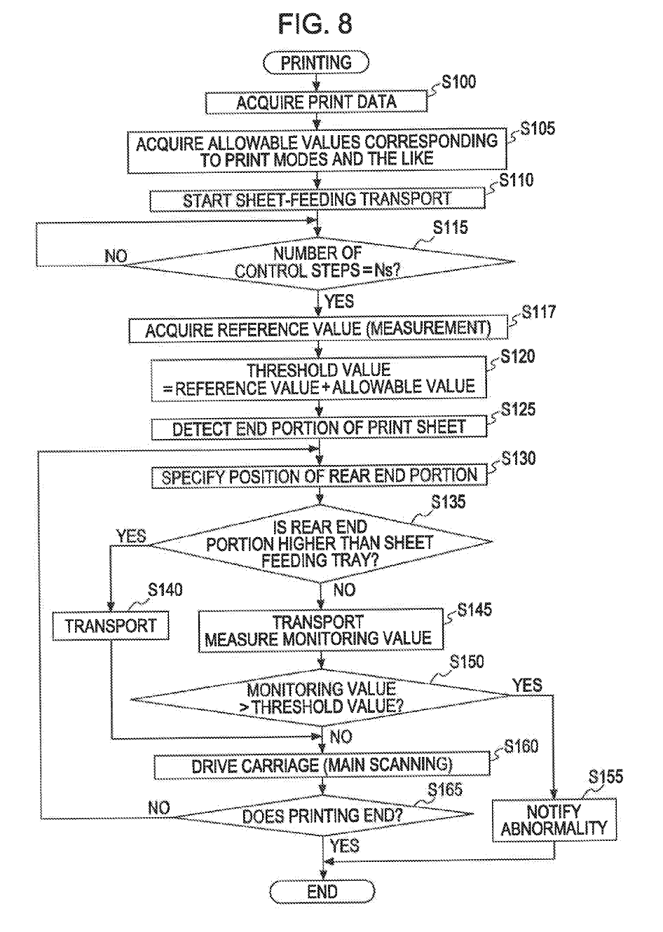

FIG. 8 is a flowchart illustrating the printing performed by the printer 1.

In step S100, the microcomputer 31 acquires the print data PD from the host computer 60. In step S105, the threshold value setting module 31c acquires designation of at least the print mode included in the print data PD, sets the print mode involved with the designation as the print mode of the subsequent printing, and reads the allowable values α corresponding to the designation one by one from the table T1. Of course, when the different allowable values α are recoded in accordance with the print modes, the sheet kinds, and the sheet sizes in the table T1, the allowable values α corresponding to the designation of the print modes, the sheet kinds, and the sheet sizes included in the print data PD are read one by one from the table T1.

In step S110, the sheet-feeding transport starts. When the sheet-feeding transport starts and the front end portion of the print sheet in the transport direction arrives at the intermediate roller 19, the PF controller 32a starts the feedback control. Of course, the feedback control is performed based on the target speed of the set print mode. In step S115, it is determined whether the number of control steps after the feedback control starts is equal to a predetermined reference number Ns. Since the acceleration period, the constant speed period, and the speed reduction period are set in the target speed in the sheet-feeding transport, as described above, the reference number Ns of the number of control steps is located in the constant speed period. That is, when the number of control steps is equal to the reference number Ns, it can be considered that the print sheet is stable in the speed to some extent and the print sheet is transported at a constant speed.

When it is determined that the number of control steps after the feedback control starts is equal to the predetermined reference number Ns (“Yes” in step S115), the load monitoring module 31b repeatedly measures the duty values d during a predetermined measurement period (during several control steps within the constant speed period) and acquires the average value thereof as the reference value D1 (step S117). That is, during the printing, the load monitoring module 31b acquires the sheet-feeding transport measurement value M1 and sets the sheet-feeding transport measurement value M1 as the reference value D1. The sheet-feeding transport measurement value M1 (the reference value D1) acquired in step S117 and the sheet-feeding transport measurement value M1 acquired when the allowable values α are calculated in advance, as described above, may not strictly have the same value, even when the print conditions such as the print modes, the sheet kinds, and the sheet sizes are the same. This is because temporal changes occur in the respective mechanism transporting the sheet in the printer 1. In the printing, the sheet-feeding transport measurement value M1 acquired currently for the printer 1, and not the sheet-feeding transport measurement value M1 acquired previously (when the allowable values α are calculated in advance), is acquired as the reference value D1.

In step S120, the threshold value setting module 31c calculates the threshold value Dth by adding the allowable value α read in step S105 to the reference value D1. The threshold value Dth is stored in the RAM. The threshold value Dth of the first print mode and the threshold value Dth of the second print mode are exemplified in FIG. 3.

However, the threshold values Dth are calculated when the sheet-feeding transport measurement value M1 acquired through the calculation of the allowable value α is set as the reference value D1, and thus these values are just references used to facilitate understanding.

When the front end portion of the print, sheet in the transport direction arrives at the PE sensor 20, the PE sensor 20 detects the sheet end of the print sheet in step S125. Then, the sheet-feeding transport ends. When the FE sensor 20 detects the front end portion of the print sheet in the transport direction in step S125, the microcomputer 31 can subsequently specify the position of the front end portion of the print sheet in the transport direction based on the rotational amount of the PF roller 17. Since the size (length) of the print sheet can be specified for the print data PD, the position of the rear end portion of the print sheet in the transport direction can be also specified,.

In step S130, the microcomputer 31 specifies the position of the rear end portion of the print sheet in the transport direction. In the initial stage, the front end portion of the print sheet in the transport direction is located at the position of the PE sensor 20. Therefore, in the transport path, the rear end portion of the print sheet in the transport direction is located at the position on the rear side of the transport direction by the length of the print sheet from the position of the PE sensor 20. In step S135, the microcomputer 31 determines whether the rear end portion of the print sheet in the transport direction is located higher than an upper end 40a2 (see FIG. 1) of the sheet feeding tray 40. When the rear end portion of the print sheet in the transport direction is located higher than the upper end 40a2 of the sheet feeding tray 40, the process proceeds to step S140. When the rear end portion of the print sheet in the transport direction is located lower than the upper end 40a2 of the sheet feeding tray 40, the process proceeds to step S145. In steps S140 and S145, the target speed in the print mode acquired and designated in step S105 is set in the PID calculation unit 32a2 by the transport instruction module 31a, and the feedback control is performed for the PF motor 14.

When the PF motor 14 performs driving to rotate the PF roller 17 and the intermediate roller 19, the print sheet is transported. In the initial sheet transport, the leading end transport is performed to transport the print sheet so that the print head 21a faces the print start position on the print sheet. When the one-time sheet-transport in steps S140 and S145 is completed, the carriage controller 32b controls the driving of the carriage 21 or the print head 21a in step S160. That is, the main scanning is performed to draw the raster lines by ejecting the ink toward the print sheet. When the main scanning is completed, it is determined whether the printing has been completed in step S165. When the printing has not been completed, the process returns to step S130. In this way, the printing transport (the sub-scanning) and the main scanning are repeated until the printing is completed. When the printing has been completed, a sheet discharging roller (not shown) is driven, the sheet-discharging transport is performed to transport and discharge the print sheet, and then the printing ends,

The same target speed is set in steps S140 and S145 and the print sheet is transported. However, during the sheet transport period in step S145, the load monitoring module 31b normally acquires the duty value d determined by the PWM unit 32a3 as the monitoring value D2. In step S150, the determination module 31d determines whether the monitoring value D2 is larger than the threshold value Dth stored in the RAM. When the monitoring value D2 is larger than threshold value Dth, the determination module 31d determines abnormality in which the print sheet is pinched between the main body 10 and the sheet feeding tray 40. In step S155, the notification module 31e transmits an abnormality signal indicating that the print sheet is pinched between the main body 10 and the paper sheet 40 to the host computer 60, and abnormality termination is performed in the printing by stopping the driving control of the PF motor 14 by the PF controller 32a and the driving control of the carriage 21 by the carriage controller 32b or the print head 21a. The notification module 31e turns on a warning LED when the main body 10 is provided with the warning LED.

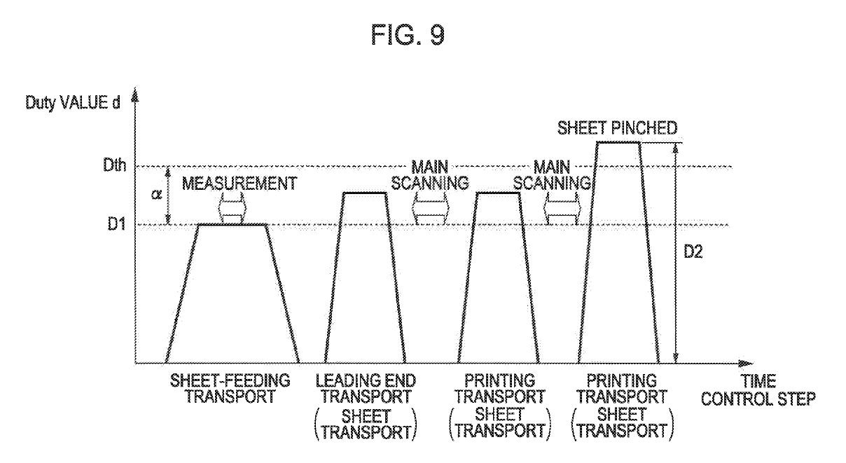

FIG. 9 is a diagram schematically illustrating a variation in the duty value d in the above-described printing. As shown in FIG. 9, the duty value d first increases during the sheet-feeding transport and the duty value d is acquired as the reference value D1 during a measurement period of the constant speed period. A value obtained by adding the allowable value α corresponding to the print mode to the reference value D1 is the threshold value Dth. When the sheet-feeding transport is completed, the next sheet transport is performed sequentially and the duty value d increases during each sheet transport. The initial sheet transport is the leading end transport. In the initial sheet transport, the rear end portion of the print sheet in the transport direction is located lower than the upper end 40a2 of the sheet feeding tray 40. Therefore, in step S145, the duty value d (the monitoring value D2) is normally monitored. When the monitoring value D2 becomes larger than the threshold value Dth, it is determined that the print sheet is pinched between the main body 10 and the sheet feeding tray 40 and the abnormality termination is performed in the printing.

When the print sheet is not pinched between the main body 10 and the sheet tray 40 and the print sheet is normally transported, the duty value d which is the same level of that of the printing transport measurement value M2 acquired in advance in accordance with the print conditions such as the print mode is generated during the sheet transport period. Therefore, the duty value d (the monitoring value D2) is lower than the threshold value Dth. However, when the print sheet is pinched between the main body 10 and the sheet feeding tray 40, the print sheet may not be transported (may be stuck). At this time, since slipping occurs between the print sheet and the PF roller 17 or the intermediate roller 19, the rotational amounts of the PF roller 17 and the intermediate roller 19 measured by the rotary encoder 33 are normal, but an excessive load (output torque) causing the slipping by resisting against the frictional resistance between the print sheet and the PF roller 17 or the intermediate roller 19 occurs in the PF motor 14.

Specifically, when the print sheet is pinched between the main body 10 and the sheet discharging tray 40, the PF motor 14 can be considered to be driven with the duty value d (the monitoring value D2) obtained by adding the excessive duty value d (corresponding to a value of the abnormality-time measurement value M3−the printing transport measurement value M2) generating the load to the degree that slipping is caused by resisting against the frictional resistance to the duty value d (corresponding to the printing transport measurement value M2) generating the load to the degree that the PF roller 17 or the intermediate roller 19 is rotatably driven at the target speed. Basically, the threshold value Dth is set between the abnormality-time measurement value M3 and the printing transport measurement value M2. Therefore, when the monitoring value D2 is larger than the threshold value Dth, it can be determined that the print sheet is pinched between the main body 10 and the sheet feeding tray 40. The duty value d for driving the PE motor 14 is different depending on the print mode, the sheet kind, and the sheet size set at that time. Thus, as in this embodiment, erroneous determination can be prevented under any print condition by regulating the allowable values α in the table T1 in accordance with at least the difference between the print modes and in accordance with a difference between the sheet kinds and a difference between the sheet sizes and by setting the threshold value Dth in accordance with at least the difference between the print modes in the printing and in accordance with the difference between the sheet kinds and the difference between the sheet sizes.

Since the print sheet pinched between the main body 10 and the sheet feeding tray 40 is not normally transported, normal printing may not be performed. Thus, when it is determined that the print sheet is pinched between the main body 10 and the sheet feeding tray 40, the printing ends. The print sheet may be pinched between the main body 10 and the sheet feeding tray 40, when a user draws and inserts the sheet feeding tray 40 during the printing to supplement print sheets. At the last stage of the sheet transport, the rear end portion of the print, sheet in the transport direction is located higher than the upper end 40a2 of the sheet feeding tray 40. That is, the rear end portion of the print sheet in the transport direction already has departed from the detachable mount position of the sheet feeding tray 40. Therefore, even when the sheet feeding tray 40 is inserted at this stage, the print sheet is not pinched between the main body 10 and the sheet feeding tray 40. Thus, when the rear end portion of the print, sheet in the transport direction is located higher than the upper end 40a2 of the sheet feeding tray 40, the print sheet is transported without the duty value d (monitoring value D2) being monitored in step 3140. That is, when the rear end portion of the print sheet in the transport direction from the detachable mount position of the sheet feeding tray 40, the monitoring of the duty value d (the monitoring value D2) is stopped. In this way, the processing load of the CPU can be reduced.

In some cases, it is not necessary to perform the abnormality determining process initially depending on the kinds or sizes of the print sheet when the printing is performed. That is, the kind and size of the print sheet, of which the rear end portion in the transport direction is located higher than the upper end 40a2 of the sheet feeding tray 40 when the PE sensor 20 detects the front end portion of the print sheet in the transport direction, is not pinched between the main body 10 and the sheet feeding tray 40 during the sheet transport period. Accordingly, between the steps S100 and S105 of the above-described flowchart in FIG. 8, the PE sensor 20 of the printer 1 may determine whether or not the print sheet is pinched between the main body 10 and the sheet feeding tray 40 during the sheet transport period based on the designation of the sheet kind or the sheet size included in the print data PD and the distance of the transport path, which is provided as information in advance, between the PE sensor 20 and the upper end 40a2. When the PE sensor 20 determines that the print sheet is not pinched between the main both 10 and the sheet feeding tray 40 during the sheet transport period, normal printing is performed and the flowchart ends without executing the steps subsequent to step S105.

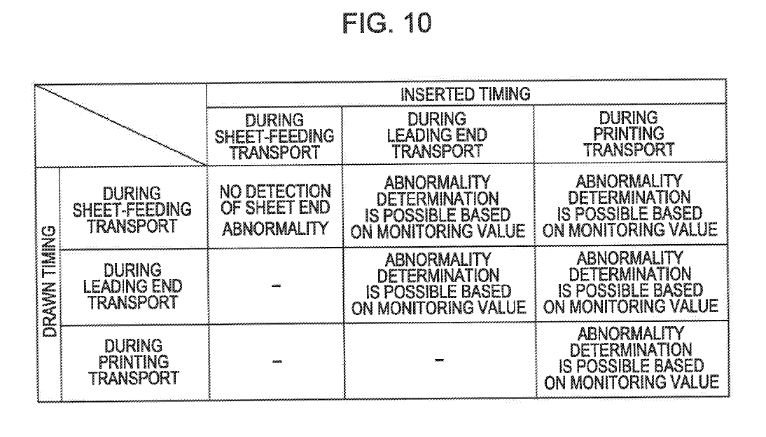

FIG. 10 is a table showing a relationship between possibility of the abnormality determination and timing at which the sheet feeding tray 40 is taken out from and inserted into the main body 10. When the sheet feeding tray 40 is taken out during the sheet-feeding transport, it can be considered that the sheet feeding tray 40 can be inserted after the sheet-feeding transport. When the sheet feeding tray 40 is taken out during the sheet-feeding transport and the sheet feeding tray 40 is inserted during the sheet-feeding transport, the front end portion of the print sheet in the transport direction does not arrive at the PE sensor 20. Thus, the processes subsequent to step S125 are not performed and abnormal printing is not performed. A time-out may be provided in a period in which the sheet-feeding transport starts and the PE sensor 20 detects the end portion of the print sheet. In addition, during the time-out, a sheet nonexistence error may be generated. When it may not be detected that the print sheet is pinched between the main body 10 and the sheet feeding tray 40 in a case in which the sheet feeding tray 40 is taken out during the sheet-feeding transport and the sheet feeding tray 40 is inserted during the leading end transport, the printing is repeated in the platen 22 (before the print sheet is transported up to the position facing the print head 21a) or at the same position on the print sheet (after the print sheet is transported up to the position facing the print head 21a).

In this embodiment, however, since the duty value d (the monitoring value D2) is monitored also during the leading end transport, it can be detected that the print sheet is pinched between the main body 10 and the sheet feeding tray 40 when it may also not be detected that the print sheet is pinched between the main body 10 and the sheet feeding tray 40 in a case in which the sheet feeding tray 40 is taken out during the sheet-feeding transport and the sheet feeding tray 40 is inserted during the printing transport (other than the leading end transport), the printing is repeated at the same position. However, since the monitoring is typically performed even during the printing transport, it can be detected that the print sheet is pinched between the main body 10 and the sheet feeding tray 40. When the sheet feeding tray 40 is taken out during the measurement period (step S117) of the sheet-feeding transport, the state of a force applied to the print sheet becomes complex during the measurement period, thereby deteriorating the precision of the reference value D1. Therefore, when the duty value d is irregular during the measurement period, the previous reference value D1 may be used without calculating the reference value D1. When a plurality of print sheets is printed under the same condition, it is not necessary to measure the reference value D1 for every sheet-feeding transport of the print sheet. For example, the reference value D1 may be measured whenever a given number of print sheets are fed. Alternatively, the reference value D1 may be measured at regular intervals.

Next, when the sheet feeding tray 40 is taken out during the leading end transport, it is assumed that the sheet feeding tray 40 is inserted thereafter. When it is not detected that the print sheet is pinched between the main body 10 and the sheet feeding tray 40 even in a case in which the sheet feeding tray 40 is taken out during the leading end transport and the sheet feeding tray 40 is inserted during the leading end transport, the printing is repeated in the platen 22 or at the same position on the print sheet. In this embodiment, however, since the monitoring is performed even during the leading end transport, it can be detected that the print sheet is pinched between the main body 10 and the sheet feeding tray 40. When it is not be detected that the print sheet is pinched between the main body 10 and the sheet feeding tray 40 even in a case in which the sheet feeding tray 40 is taken out during the leading end transport and the sheet feeding tray 40 is inserted during the printing transport. (other than the leading end transport), the printing is repeated at the same position on the print sheet. However, since the monitoring is performed even during the printing transport, it can be detected that the print sheet is pinched between the main body 10 and the sheet feeding tray 40.

When the sheet feeding tray 40 is taken out during the printing transport (other than the leading end transport), it can be considered that the sheet feeding tray 40 is inserted during the printing transport (other than the leading end transport). Even in this case, when it may not be detected that the print sheet is pinched between the main body 10 and the sheet feeding tray 40, the printing is repeated at the same position on the print sheet. In this embodiment, however, since the monitoring is performed even during the printing transport (other than the leading end transport), it can be detected that the print sheet is pinched between the main body 10 and the sheet-feeding tray 40.

### 4. MODIFIED EXAMPLES

In the above-described embodiment, the load monitoring module 31b monitors the duty value d in the duty ratio DR output by the PWM unit 32a3, but may monitor the duty ratio DR to acquire the measurement values M1, M2, and M3, the reference value D1, and the monitoring value D2. Alternatively, the load monitoring module 31b may monitor the voltage Vm in the PF motor 14 to acquire the measurement values M1, M2, and M3, the reference value D1, and the monitoring value 32 or may monitor the current Im in the PF motor 14 to acquire the measurement values M1, M2, and M3, the reference value D1, and the monitoring value D2. The PID calculation unit 32a2 may indirectly monitor the driving supply of the PF motor 14 by measuring the control voltage output to the PWM unit 32a3.

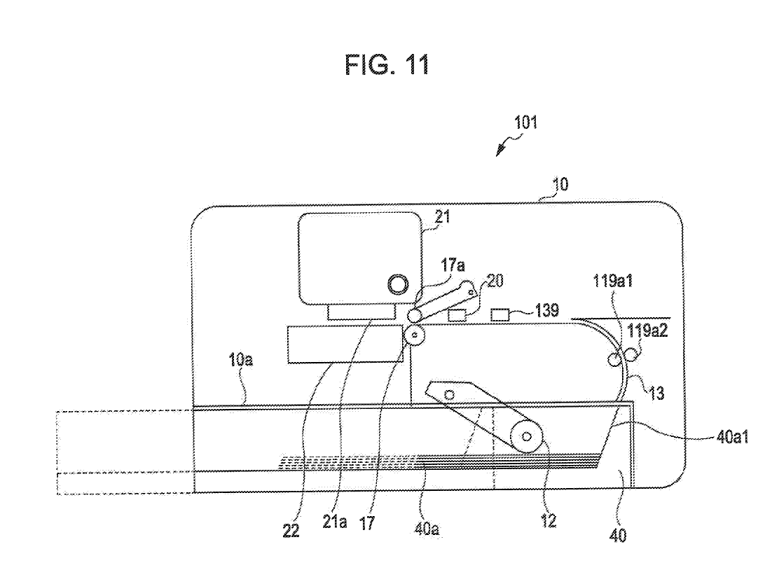

FIG. 11 is a diagram schematically illustrating the configuration of a printer 101 according to a modified example. In FIG. 11, the same reference numerals as those in FIG. 1 are given to the same elements as those in FIG. 1. The printer 101 includes no intermediate roller actively driven in a rotatable manner, and is provided with intermediate driven rollers 119a1 and 119a2 on both the inner and outer sides of the print sheet curved in the transport guide 13. When the print sheet is pinched between the main body 10 and the sheet feeding tray 40 even in the case in which no intermediate roller actively driven in the rotatable manner is provided, the load of the PF motor increases and thus the duty value d increases. Therefore, according to the method of the above-described embodiment, it can be determined that the print sheet is pinched between the main body 10 and the sheet feeding tray 40.

In the modified example, a sheet kind sensor 139 is installed near the PE sensor 20. The sheet kind sensor 139 according to the modified example emits detection light toward the print sheet and measures the reflected state of the detection light to determine the kind of the print sheet. In the modified example, the threshold value setting module 31c sets the threshold value Dth by adding the allowable value α to the reference value D1. However, the allowable value α corresponding to the kind of print sheet determined by the sheet kind sensor 139 is acquired from the table T1. In this way, since the appropriate threshold value Dth can be set, it is possible to prevent erroneous determination.

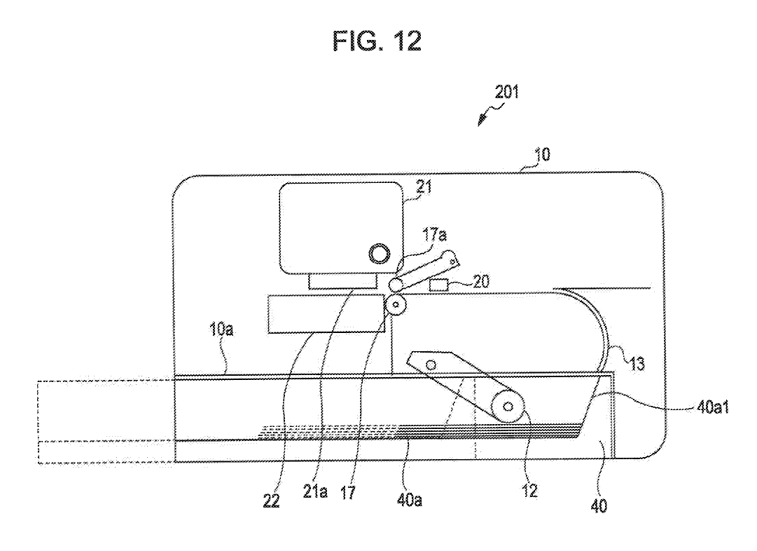

FIG. 12 is a diagram schematically illustrating the configuration of a printer 201 according to a modified example. In FIG. 12, the same reference numerals as those in FIG. 1 are given to the same elements as those in FIG. 1. The printer 201 does not include the intermediate roller and the intermediate driven roller rotated actively and passively. Even in this case, when the print sheet is pinched between the main body 10 and the sheet feeding tray 40, the load of the PF motor increases and thus the duty value d increases. Therefore, according to the method of the above-described embodiment, it can be determined that the print sheet is pinched between the main body 10 and the sheet feeding tray 40.

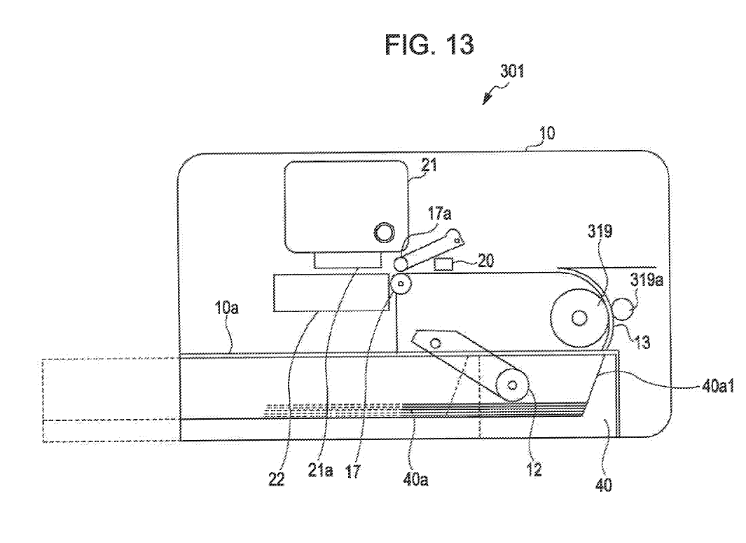

FIG. 13 is a diagram schematically illustrating the configuration of a printer 301 according to a comparative example in FIG. 13, the same reference numerals as those in FIG. 1 are given to the same elements as those in FIG. 1. The printer 301 includes an intermediate roller 319, which is actively driven in a rotatable manner, on the inner side of the print sheet curved in the transport guide 13. An intermediate driven roller 319a is disposed on the outer side of the print sheet curved to correspond to the intermediate roller 319. In the comparative example, since the intermediate roller 319 and the PF roller 17 are coupled together to the PF motor, the intermediate roller 319 and the PF roller 17 are driven in a rotatable manner by the driving of the PF motor. The diameter of the intermediate roller 319 is larger than that of the PF roller 17, but a gear ratio is set so that the transport speed of the print sheet by the intermediate roller 319 and the PF roller 17 is consistent. Thus, when the print sheet is pinched between the main body 10 and the sheet feeding tray 40, a tensional force tensioning the print sheet is applied by the rotational driving of the PF roller 17, and thus the intermediate roller 319 is pressed inward. Then, since a large frictional resistance occurs between the intermediate roller 319 and the print sheet or around the rotational shaft of the intermediate roller 319, the PF motor may not be driven. Even in this case, since the PF roller 17 is not rotated either, abnormality can he determined by detecting the rotational amount by the rotary encoder without using the method of the invention.

What is claimed is:

1. A printing apparatus comprising:
a sheet feeding tray loading a print medium and detachably mounted to a main body;
a transport roller rotated by driving of a transport motor to transport the print medium while coming into contact with the print medium supplied from the sheet feeding tray to a transport path;
a print condition setting unit setting a print mode among a plurality of print modes in which transport speeds are different;
a control unit controlling the driving of the transport motor based on the set print mode and a rotational amount of the transport roller;
a threshold value setting unit setting a threshold value corresponding to at least the set print mode; and
a determination unit measuring a monitoring value indicating a load of the transport motor during a transport period of the print medium and determining there is an abnormality when the monitoring value is larger than the set threshold value.

2. The printing apparatus according to claim 1, wherein the threshold value setting unit sets, as the threshold value, a sum of a sheet-feeding transport measurement value indicating a load of the transport motor during a period in which the print medium is transported up to a predetermined sheet-feeding transport end position of the transport path and an allowable value that varies depending on at least the set print mode.

3. The printing apparatus according to claim 2, wherein the threshold value setting unit selects the allowable value corresponding to the set print mode among the plurality of allowable values calculated in advance in accordance with at least the print mode and calculated based on a difference between the sheet-feeding transport measurement value and a printing transport measurement value indicating a load of the transport motor during a transport period of the print medium to perform printing and a difference between the printing transport measurement value and an abnormality-time measurement value indicating a load of the transport motor when predetermined abnormality occurs, and sets the threshold value using the selected allowable value.

4. The printing apparatus according to claim 1, wherein the threshold value setting unit sets the threshold value in accordance with kinds of print media and sizes of the print media in addition to a difference between the print modes.

5. The printing apparatus according to claim 1,
wherein the settable print modes include at least a first print mode and a second print mode in which the transport speed is slower than the first print mode, and
wherein when the kind of print medium is a plain sheet and the print mode is set to the first print mode, the threshold value setting unit sets the threshold value larger than the threshold value set when the kind of print medium is the plain sheet and the print mode is set to the second print mode.

6. The printing apparatus according to claim 1, wherein the determination unit measures the monitoring value after the print medium is transported up to a predetermined sheet-feeding transport end position of the transport path.

7. The printing apparatus according to claim 1, wherein the determination unit stops measuring the monitoring value during a period after a rear end portion of the print medium in the transport direction departs from a detachable mount position of the sheet feeding tray during the transport period of the print medium.

8. A method performed by a printing apparatus which includes a sheet feeding tray loading a print medium and detachably mounted to a main body, a transport roller rotated by driving of a transport motor to transport the print medium while coming into contact with the print medium supplied from the sheet feeding tray to a transport path, and a control unit controlling the driving of the transport motor based on the set print mode and a rotational amount of the transport roller, the method comprising:
setting a print mode among a plurality of print modes in which transport speeds are different;
setting a threshold value corresponding to at least the set print mode;
measuring a monitoring value indicating a load of the transport motor during a transport period of the print medium; and
determining abnormality when the monitoring value is larger than the set threshold value.

9. A printer comprising:
a tray detachably mounted on the printer;
a motor used for rotating a roller moving a print medium;
a reception unit receiving designation of a print mode;
and
a controller stopping driving of the motor when determining that the print medium is pinched between the printer and the tray using the print mode.
